(19) United States
(12) Patent Application Publication
(10) Pub. No.: US 2014/0062774 A1
(43) Pub. Date: Mar. 6, 2014

(54) PERFORMING SEAMLESS POSITIONING USING VARIOUS LOCATION TECHNIQUES

(71) Applicants: Gregory Brooks Hale, Orlando, FL (US); Gregory Gerard Johnson, Windermere, FL (US); Jeffrey R. Schenck, Clermont, FL (US)

(72) Inventors: Gregory Brooks Hale, Orlando, FL (US); Gregory Gerard Johnson, Windermere, FL (US); Jeffrey R. Schenck, Clermont, FL (US)

(73) Assignee: DISNEY ENTERPRISES, INC., Burbank, CA (US)

(21) Appl. No.: 13/596,210

(22) Filed: Aug. 28, 2012

(51) Int. Cl. G01S 19/48

(52) U.S. Cl. 342/357.31

(57) ABSTRACT

A computing device may rely on GPS and IR communication to determine its current location. The limits of GPS may prevent it from reliably providing location data to the computing device in a variety of situations such as in downtown metropolitan areas, geographic regions with thick canopies, in buildings, and the like. As a result, a second communication technique may also be used to provide location data to the computing device. For example, an IR transmitter may transmit location data to the computing device which, in turn, uses the location data to identify its current location. In addition, the computing device may receive or transmit supplemental data using the second communication technique for, e.g., synchronizing the computing device to a real-time event happening at the identified location or providing the location of the device to a central computing system.

### BACKGROUND

1. Field of the Invention

Embodiments presented in this disclosure generally relate to receiving location data using two or more different location techniques and receiving or transmitting supplemental data via at least one of the location techniques.

2. Description of the Related Art

Global Positioning System (GPS) permits mobile devices to use satellites to approximate the current location of the device. Specifically, the mobile device receives data from three or four satellites which includes a timestamp as well as a current location of the satellite. From this, the mobile device calculates a sphere where the outer surface of the sphere defines all the possible locations of the mobile device. By determining where the spheres for each of the respective satellites intersect, the mobile device can identify its current location.

The effectiveness of GPS decreases, however, as the celestial view of the mobile device is obstructed. For example, it is well known that GPS devices do not work well, or at all, in metropolitan areas with tall buildings or in areas with a thick tree canopy. Further, if the mobile device enters a building, the GPS signal may be blocked completely, and thus, the mobile device is unable to determine its current location.

### SUMMARY

One embodiment provides method that receives a plurality of signals at a device configured with a GPS receiver and a wireless signal receiver. Based on the plurality of signals, the method identifies a first location of the device using location data received from the GPS receiver, identifies a second location of the device using location data received from the wireless signal receiver, and receives supplemental data associated with a point of interest. The method determines an identified location of the device based on at least one of the first and second locations of the device. Upon determining that the identified location is within a predefined distance from the point of interest, the method synchronizes, based on the supplemental data, a media output of the device to an ongoing event corresponding to the point of interest.

Another embodiment provides a device including a GPS receiver configured to receive first location data and a wireless signal receiver configured to receive second location data. The device further includes a processor configured to determine a location of the device using one of: the first location data received from the GPS receiver and the second location data received from the wireless signal receiver. Upon determining that the location of the device is within a predefined distance from a point of interest, the processor is configured to synchronize, based on received supplemental data associated with the point of interest, a media output of the device to an ongoing event corresponding to the point of interest.

Another embodiment provides a device including a GPS receiver configured to receive first location data and an optical data receiver configured to receive second location data. The device including a processor configured to, upon determining at least one criteria is met, identify a location of the device based on one of the first location data and the second location data. The device including a wireless signal transmitter configured to transmit a wireless message containing the identified location of the device.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a geographic region covered by both GPS and infrared transmitters, according to one embodiment disclosed herein.

FIG. 2 is a computing device that receives location data from both GPS and infrared transmitters, according to one embodiment disclosed herein.

FIG. 3 is a geographic region covered by both GPS and infrared transmitters, according to one embodiment disclosed herein.

FIGS. 4A-4B is a geographic region with integrated GPS and infrared location systems, according to embodiments disclosed herein.

FIG. 5 is a method for determining the location of the device in FIG. 2, according to one embodiment disclosed herein.

FIGS. 6A-6B illustrate a system and method for transmitting the location of the device in FIG. 2 to a separate computing system, according to embodiments disclosed herein.

FIGS. 7A-7B illustrate a system and method for bi-directional communication in the system illustrated in FIG. 6A, according to embodiments disclosed herein.

### DETAILED DESCRIPTION

The limits of GPS may prevent a computing device from reliably providing location data to the computing device in a variety of situations such as in downtown metropolitan areas, geographic regions with thick canopies, in buildings, and the like. As a result, a computing device may rely on GPS and a second, different communication technique (e.g., IR, RF, WiFi, and the like) to determine its current location. The second communication technique may also be used by the computing device to determine its location. For example, an IR transmitter may transmit location data to the computing device which, in turn, uses the location data to identify its current location. In addition, the computing device may receive supplemental data from the second communication technique that, for example, synchronizes the computing device to a real-time event happening at the identified location—e.g., an audio/visual presentation. The device may also transmit supplemental data via the second communication technique. The transmitted supplemental data may be used to, for example, track a location of the device or determine an operational status of the device.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

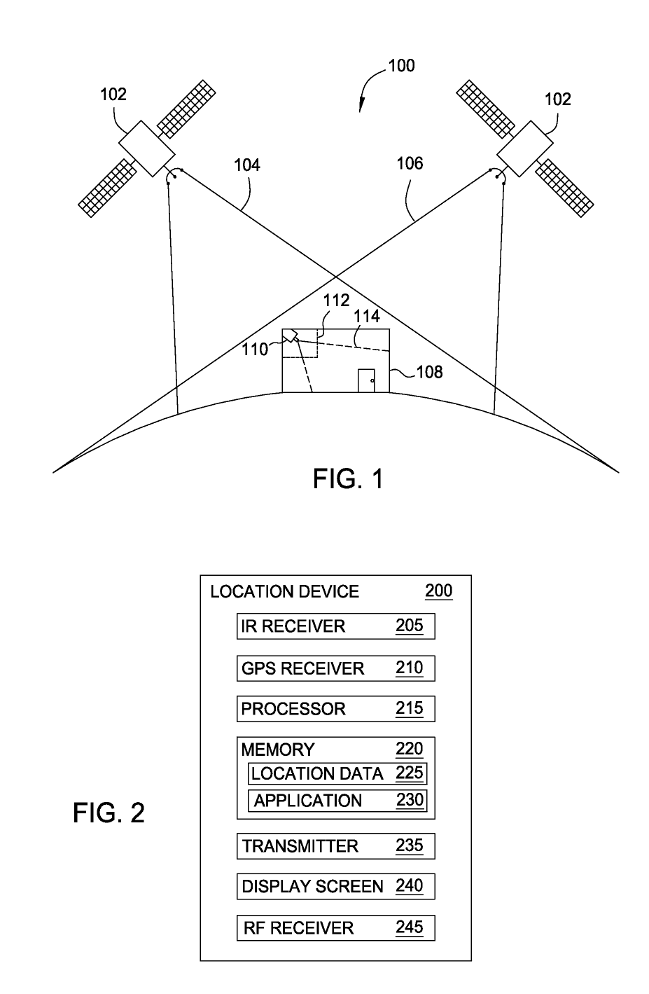

FIG. 1 is a geographic region covered by both GPS and infrared transmitters, according to one embodiment disclosed herein. The system 100 includes GPS satellites 102 (i.e., GPS transmitters) that emit a GPS signal in regions 104 and 106. In these signal regions 104, 106, a GPS enabled device is able to receive information from the satellites 102. The device is able to determine its location in 3-D space.

However, the GPS enabled device may be unable to calculate a location using the satellites 102 even if it is within the regions 104 and 106. For example, the device may be in the building 108 which blocks or attenuates the signals emitted from the satellites 102.

The system 100 includes a line of site (LOS) signal source such as an IR transmitter 110 in the building 108 (as shown by cutout 112) to provide a signal to the device (not shown in FIG. 1) containing location data that can be used by the device to determine a geographic location. Like with the satellites 102, the IR transmitter 110 (e.g., a laser or one or more light emitting diodes) may have an associated signal region 114 where an IR enabled device is able to receive location data from the IR transmitter 110. Accordingly, a device that has both GPS and IR receivers is able to receive location data so long as it is in the signal regions of at least the satellites 102 or the IR transmitter 110. As used herein “location data” may be a geographic region in which the device is located, a precise location of the device or the signal transmitter (e.g., longitudinal or latitudinal coordinates) or data that may be used by the device to calculate a geographic region or a precise location (e.g., the location of the GPS satellite and a time).

IR transmitter 110 modulates a data signal using infrared light (wavelengths of approximately 0.74 microns to 300 microns) as the carrier frequency. Unlike other terrestrial location methods (e.g., cell tower triangulation, RFID, or WiFi) IR transmitter 110 relies on Line-of-Sight (LOS) to transmit location data to the device. That is, assuming no reflections, if the device is in the region 114 but its view of IR transmitter 110 is obstructed, the device is unable to receive location data from the IR transmitter 110. Although the IR spectrum is used herein, the transmitter 110 may use light in other spectrums to communicate, such as visible light.

In one embodiment, the IR transmitter 110 transmits location data that corresponds to the location of the IR transmitter 110. For example, the IR transmitter 110 may not be able to provide location data to the device that informs it where in the sensor region 114 the device is precisely located. Instead, the location of the IR transmitter 110 is used as the location of the device. That is, the device knows that is located within building 108 because it received location data from IR transmitter 110. Specifically, the IR transmitter 110 may transmit to the device map coordinates in a data packet (e.g., longitude and latitude coordinates, polar coordinates, altitude, a local coordinate system, an identifier code of the transmitter, and the like) that corresponds to the transmitter's 110 location. Alternatively, the IR transmitter 110 may transmit a key or ID that the device can then match to a specific geographic location, for example, building 108. In this manner, the device at least knows it is located within a defined geographic region.

In one embodiment, the sensor region 114 may be approximated as the geographic region that contains the device (i.e., the current location of the device). This region 114 may, or may not, include the location of the IR transmitter 110. Thus, instead of basing the device's current location on the location of the transmitter 110, the current location is the geographic region associated with the sensor region 114.

In one embodiment, the IR transmitter 110 may provide location data that specifies where in the sensor region 114 the device is located—e.g., longitudinal and latitudinal coordinates that form a bounded region. Thus, similar to how GPS provides the device with a location within the regions 104, 106, the device detects its location within region 114.

In one embodiment, the IR transmitters may pan or rotate. Advantageously, a panning IR transmitter 110 may be able to cover a larger area without the additional cost of adding more IR transmitter 110. The IR transmitter 110 may modify the location data sent to a device based on the current pan (i.e., azimuth angle at which the IR transmitter 110 is aimed) of the transmitter 110. That is, if the IR transmitter 110 has rotated 15 degrees relative to a start position or other reference point, this location data may inform the device that it is in a different sensor region 114 than if the IR transmitter has rotated 25 degrees when the device receives the location data. Accordingly, an IR transmitter 110 may be associated with a plurality of different sensor regions 114.

In one embodiment, the device may receive an IR signal from two or more IR transmitters 110. The signal intensity may be used to determine which of the two IR transmitters 110 should be used to determine which location data should be used. For example, the two IR transmitters 110 may transmit location data using two different wavelengths (to prevent collisions). The device may determine the intensity of the received signals and use the location data from the IR transmitter 110 that provides the highest intensity signal. Alternatively, if the device receives an IR signal from two different transmitters 110, the device may determine that it is located in geographic region where the respective sensor regions 114 overlap.

Although IR is discussed as the technique for providing location data when GPS is not available, this disclosure is not limited to IR. In one embodiment, the device may use RF location techniques when in building 108 to receive location data. For example, once the device determines that GPS is not available, it may use a cellular network to determine its location.

Although FIG. 1 illustrate a system where the GPS signal may not be available, a secondary communication technique may be used in geographic regions where the GPS signal is still available but is unreliable. For example, the IR transmitter 110 may be placed in a wooded region or in a downtown with tall obstacles that may intermittently block signals from the orbiting GPS satellites.

In one embodiment, IR and RF (e.g., WiFi, Bluetooth, AM/FM, etc.) location techniques may provide supplemental data in addition to transmitting location data. That is, because GPS signal is typically limited to transmitting location data and time stamps, a device may use a second wireless communication technique for receiving synchronization data, audio/visual data, data files, and the like for conveying information associated with the current location of the device. For example, the device may use the GPS signal to identify a location of the user but rely on the second communication technique to receive an audio presentation associated with a point of interest. Accordingly, the device uses the GPS signal to ensure that the device is within a certain distance from the point of interest, and thus, should play the audio presentation. For clarity, the present embodiments primarily disclose IR as the second communication technique, but any wireless communication technique that is capable of providing location data as well as supplemental data is within the scope of this disclosure.

FIG. 2 is a computing device that receives location data from both GPS and infrared transmitters, according to one embodiment disclosed herein. The location device 200 may be a portable computing device that is carried around by a user. Additionally, the location device 200 may be attached to a separate, mobile device. For example, the location device 200 may be a tablet computer, smartphone, or a tracking device attached to mobile machinery.

The location device 200 comprises an IR receiver 205, GPS receiver 210, processor 215, and memory 220. In some embodiments the location device 200 may include a transmitter 235, display screen 240, and RF transceiver 245.

The IR receiver 205 may be any electrical component capable of detecting infrared light. If an RF location method is used, the receiver 205 may correspond to the communication medium used for that location method. For example, the location device 200 may include a wireless network interface if WiFi is used to provide location data.

GPS receiver 210 receives signals from a plurality of GPS satellites that, when combined, identify a location of the device 200. The processor 215 may perform the necessary logic to calculate the location using information received from the GPS satellites. The processor 215 may be any special or general purpose processor. Further, device 200 may include any number of processors or processors with multiple cores.

The memory 220 may be implemented by any available data storage technology such as random access memory (e.g., DRAM or flash memory), a hard disk drive, solid state device (SSD), or flash memory storage drive. The memory 220 contains location data 225 and an application 230. The location data 225 may be, for example, longitudinal and/or latitudinal coordinates associated with the device 200, a specific geographic area (e.g., a room within a building), a location of an IR transmitter or its sensor region, a predicted location based on past locations of the device 200, and the like.

The application 230 may use the location data 225 to perform a task. In one embodiment, the application 230 may be a mapping program that displays a current location using a test interface, graphic interface, or simple signal lights and/or sounds. In another embodiment, the application 230 may play a media presentation (e.g., an image, video, or sound) stored in memory 220 when the device 200 enters a particular geographic region. Further embodiments for using the location data 225 and application 230 will be discussed later.

In some embodiments, the transmitter 235 permits the device 200 to communicate bi-directionally. In one embodiment, the transmitter 235 may be combined with the IR receiver 205 to generate an IR transceiver with which the device 200 may both receive and transmit data to, for example, IR transmitter 110. Alternatively, the transmitter 235 may use an RF communication method. For example, an RF transmitter may be used to transmit the location of the device 200 to a remote computing system regardless of whether the device 200 is able to communicate with an IR transmitter 110. Furthermore, the device 200 may have an RF receiver 245 (or other type of wireless communication module) for receiving data from the remote computing system without having to rely on IR data communication. Nonetheless, the transmitter 235 and RF receiver 245 are optional and may not be needed if, for example, the device is used only to provide the user with her current location.

The display screen 240 may be any type of display for providing visual or tactile information to the user including, for example, images and video. In one embodiment, screen 240 is a touch screen allowing the user to interact with displayed content by touching the screen. Alternatively the user may interact with the displayed content via control elements such as a trackball or keys. Moreover, the location device 200 may have audio speakers for outputting sound that may accompany the video generated on the display screen 240. In one embodiment, the device 200 uses the receiver 205 to receive supplemental data associated with, for example, a multimedia presentation. The supplemental data may synchronize a presentation on the display screen 240 to a real-time event such as a video presentation. Alternatively, the display screen 240 (or any type of user interface) may be omitted from embodiments that do not require user communication. For example, the location device 200 may be a tracker placed on a vehicle which may convey its location, using transmitter 235, to a remote computing system.

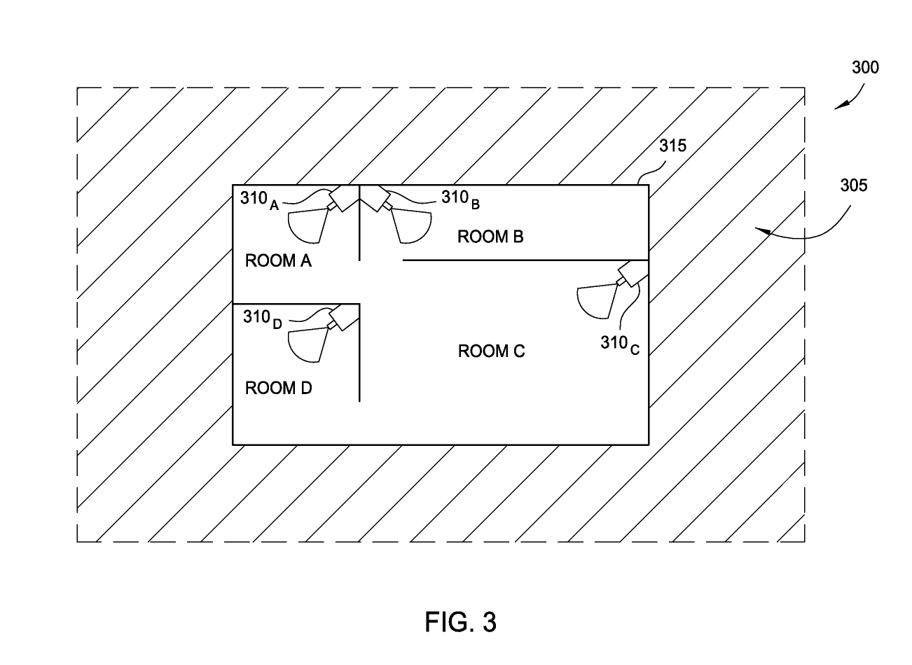

FIG. 3 is floorplan view of a region covered by both GPS and infrared transmitters, according to one embodiment disclosed herein. Specifically, the system 300 illustrates an embodiment where the location device 200 (shown in FIG. 2) may switch from using GPS to using IR (or other wireless location technique) to receive location data 225 (shown in FIG. 2). Shaded region 305 illustrates a geographic region in which GPS may be used to provide location data 225 to the device 200. That is, when in this region 305, the location device 200 is able to receive signals from the GPS satellites. However, once the device enters into the building 315 (where the roof is not visible in the figure), the device 200 may be unable to receive a GPS signal.

The transition from using GPS to using IR may be seamless—i.e., performed without an explicit user command or request. Once the device 200 determines that the GPS signal is no longer available but an IR signal is found, it may automatically begin updating the location data 225 based on the data received by an IR transmitter. Conversely, once the device 200 leaves the building 315 and an IR signal is no longer available, the device 200 may seamlessly transfer from using IR signals back to using GPS signals. In one embodiment, the device 200 may not inform the user of the switch—e.g., the device 200 includes a unified user interface for both of the location determining systems. When desired, the device 200 may inform the user of the switch by an appropriate output via a display screen, an audible sound, or other signaling or notification technique.

To facilitate IR communication, the system 300 includes a plurality of IR transmitters 310_{A-D} located in different rooms of the building 315. In one embodiment, the sensor regions of each of the IR transmitters 310_{A-D} do not overlap. That is, an IR receiver on the location device 200 may be in communication with at most one of the transmitters 310_{A-D} at any given time. Assuming that each transmitter 310_{A-D} has a sensor region that includes the entire room it is located in, the location device is able to receive location data 225 from a transmitter 310_{A-D} via IR communication. If, for example, the device 200 is located in Room B, the IR transmitter 310_{B} may transmit a data packet that includes location data that corresponds to the location of the IR transmitter 310_{B}. In one embodiment, the location data 225 may be the longitude and latitude coordinates of the transmitter 310_{B}, the geographic region defined by the room, or even the geographic region defined by the building. If the device 200 has a mapping application, it may use the location data 225 to inform the user that she is currently located in Room B of building 315. As mentioned previously, the location data 225 may not specify where in Room B the device is located. Instead, the location data 225 may be based on the known location of the transmitter 310_{B} or its sensor region.

In another embodiment, the transmitter 310_{B} may transmit a data packet that includes an ID associated with transmitter 310_{B}. The location device 200 may store in memory 220 a predefined map that has the location of each of the transmitters 310_{A-D}. Once the device determines that the ID corresponds to the IR transmitter 310_{B} in Room B, the display screen 240 may inform the user of her current location. For example, the screen 240 may highlight Room B or show a beacon flashing in Room B.

As the user carries the device out of Room B, a different transmitter 310_{A,C,D} may begin to transmit data packets to the location device 200. So long as the device 200 does not enter a portion of the building 315 not covered by at least one of the sensor regions of the IR transmitters 310_{A-D}, the location device 200 continues to receive updated location data.

Of course, more than one IR transmitter may be used to provide location data in a single room. However, in one embodiment, the IR transmitters in the same room may be adjusted such that their sensor regions do not overlap. If more and more IR transmitters are added to a room, the system 300 may be able to provide more and more accurate location data 225 (i.e., identify a smaller geographic region in which the device 200 is located). Alternatively, adding more IR transmitters may improve the location data 225 by improving coverage in the room. That is, removing spots of the room where the wireless coverage is poor may provide more accurate location data 225—i.e., being able to determine the device is in the room.

In one embodiment, the device 200 may predict its current location even if it is not currently receiving location data 225 from either GPS or IR transmitters. In one embodiment, if the device stops detecting a GPS or IR signal, the device 200 continues to use the most recent determined location as the current location. In one embodiment, the device 200 may reference past locations of the device to interpolate a trajectory of the device 200. For example, if the device 200 was in Room A, then Room B, then Room C, but the IR signal was lost, the device 200 may assume the user is moving from Room C to Room D and predict that Room D (or some intermediate point between Room C and D that is not covered by an IR sensor region) is the current location of the device. The location may be updated once the device 200 again receives a GPS or IR signal.

In one embodiment, the device 200 may use location data received from both a GPS signal and an IR signal to determine the device's location. For example, the device 200 may be in a building that still receives a GPS signal, but in order to determine which floor in the building the device 200 is on, the device 200 may communicate with an IR transmitter 310. That is, even though GPS provides elevation, the signal may not have the desired granularity to identify a particular floor in the building. In this manner, the GPS signal provides the latitude and longitude while the IR signal provides a precise floor.

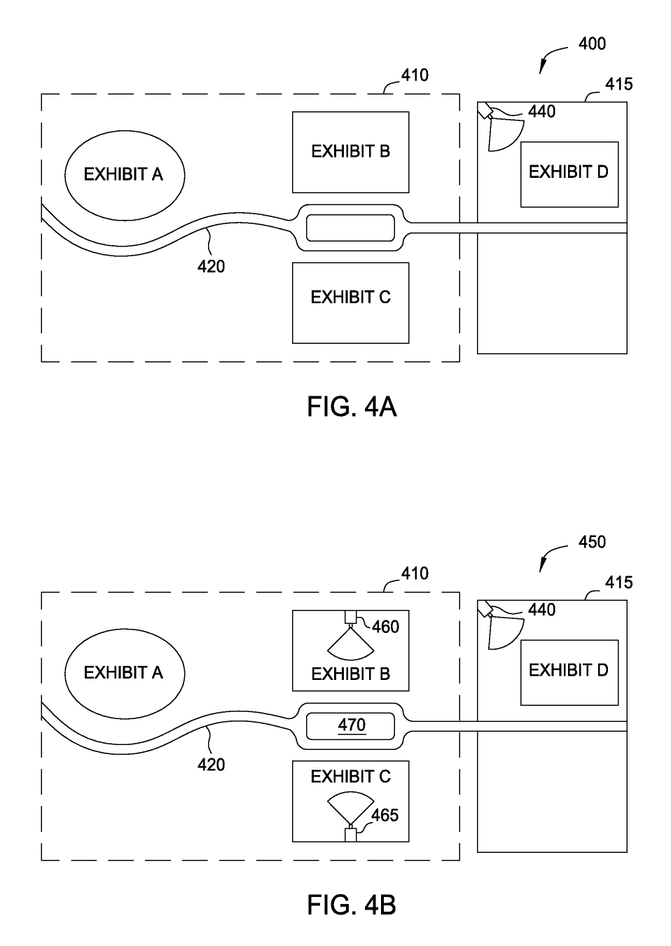

FIGS. 4A-4B is a geographic region with integrated GPS and infrared location systems, according to embodiments disclosed herein. FIG. 4A illustrates an attraction 400 with a geographic region covered by GPS and a geographic region covered by IR communication. Specifically, the box 410 illustrates a region where a GPS signal is available while building 415 illustrates a region where only IR communication is available.

The attraction 400 may be a museum, zoo, amusement park, theme park, and the like. However, the embodiments discussed herein may also be applied to pedestrian greenways, city streets (where building 415 is, for example, a tunnel), and the like.

The attraction 400 includes four exhibits (i.e., points of interests) which are accessed by path 420 which is traversed by, for example, a user carrying a location device 200. Exhibit A may be an animal exhibit. Once the location device 200 determines, using the location data 225, that it is within a predefined distance from Exhibit A, the application 230 may be configured to play content that provides additional information about the animals in the Exhibit A.

Exhibit B may be an informational display. Once the location device 200 determines using GPS that it is within a predefined distance from Exhibit A, the device 200 may automatically start application 230. Here, application 230 may be a game related to the information display. The device 200 may include buttons or other interactive interfaces so that a user can play the game.

Exhibit C may be an ongoing event or live event that is occurring at the location—e.g., a movie, animatronic shown, audio presentation, a play with real actors, a parade and the like. Once the location device 200 is within a predefined distance from Exhibit C, the device 200 may automatically start application 230. Here, the device 200 may provide text to go along with the live event, e.g., a movie, playing at the exhibit. Instead of receiving only location data, the device 200 may also receive supplemental data that synchronizes an application on the device 200 the movie playing at Exhibit C. For example, the user may be hearing impaired and the device 200 may have saved in memory an application that provides text for the movie. After receiving the supplemental data via IR (or other wireless communication), the device 200 presents the text in synch with the movie. The supplemental data may be a time code associated with the movie that informs the device 200 when the movie started. The device 200 can then determine an offset between the current time and the time code to synchronize the media output (e.g., the text) with the movie. Additionally, the location device 200 may the supplemental data to display text from a different language if the user of the device 200 does not speak the language provided with the exhibit's video. In one embodiment, instead of receiving synchronization data, the supplemental data may be streaming data that includes the text the device 200 should display. That is, the video system of Exhibit C may be linked to the IR system that provides the streaming data to the device. As the video presentation progresses, the system instructs the IR system to stream data containing the text to the device 200. This may avoid having to store the text in the memory of the device 200.

Moreover, Exhibit C may be a video or other presentation part of a current event, such as a parade, that is moving past a user holding the device 200. A parade float may contain an IR or other wireless transmitter that broadcasts to an area around the float. This transmitter may transmit a current location of the float as well as supplemental data for synchronizing an audio presentation. Since the device 200 is located outdoors, the device 200 may use GPS to determine its current location. The device 200 then compares its location to the location of the float that was received using the IR transmitter to determine whether the device 200 is within a defined distance from the float's location. If so, the device 200 uses the supplemental data such as a synch message or streaming data to present a synchronized media presentation to the user.

Exhibit D may be an animatronic show that constantly plays in an ongoing show and may be inside building 415, and thus, a GPS signal is unavailable. Instead, the device 200 receives location data 225 from the transmitter 440—e.g., a identifier code of the transmitter. Based on the location data 225, the device 200 identifies its geographic location. In this embodiment, by virtue of receiving a signal from the transmitter 440, the device 200 may determine it is close enough to Exhibit D to present an associated media presentation. For example, the transmitter 440 may provide supplemental data to the device 200 for synchronizing the device to the animatronic show. Specifically, the IR transmitter 440 may send supplemental data including codes that identify the location and the show time. The show time may be the amount of time into, or from the start of the show or presentation, or any other time offset relative to a fixed time in the ongoing show. Based on the code received, the device 200 recognizes when to start playing stored content found in memory 220 so the content playback is synchronous with the ongoing show or presentation in the exhibit. Thus, the user of the device 200 does not need to wait for the beginning of the next show. Alternatively, the device 200 may use the determined location to transmit, using a wireless communication technique, a signal to a server or show controller that indicates the user is approaching a predetermined area which may, in turn, trigger the show as the user arrives.

In one embodiment, the device 200 provides text captions that are synchronized with a theater presentation in Exhibit D. The portable device 200 receives time codes, synch data, date, or time of day in a synch message from the IR transmitter 440 located near Exhibit D. Caption text for the entire theater presentation may be stored in the memory 220 of device 200, or, alternatively or in addition may be streamed to device 200 or dynamically generated within device 200 by software processes. The device 200 receives the synch message sent by the transmitter 440, extracts the current show time, and displays the appropriate text in time with the show. Thus, the location device 200 may use both the location data 225 and synch messages (i.e., supplemental data) provided by the IR transmitter 440 to display text or video to the user that corresponds to the current show time or show time code of the exhibit. Further information about synchronizing content presented on a device to an external event is further described in U.S. Pat. No. 7,881,713, U.S. Pat. No. 7,224,967, and U.S. Pat. No. 6,785,539 all entitled “System and Method of Wirelessly Triggering Portable Devices” which are incorporated by reference in their entirety.

FIG. 4B illustrates a system 450 that uses IR transmitters to provide location data even if a geographic area receives a reliable GPS signal. System 450 is similar to system 400 except for the addition of IR transmitters 460 and 465. In one embodiment, the Exhibits B and C may be spaced closely together. Because of the accuracy limitations of GPS (typically accurate by three meters), location data 225 generated by GPS may not the necessary resolution to determine whether the device 200 is at Exhibit B or Exhibit C. Accordingly, to provide more precise resolution, the system 450 includes IR transmitter 460 corresponding to Exhibit B and IR transmitter 465 corresponding to Exhibit C.

The IR transmitters 460, 465 may have their sensor regions adjusted (e.g., by adjusting their emission power or by using reflectors, masks, and/or directional focusing constraints) so that the regions cover only the portion of the path 420 between the respective exhibit and the median 470. Alternatively, because IR transmitters 460 and 465 are directional, the user may change the orientation of the device 200 and determine which IR transmitter to access even if the sensor regions overlap. For example, the user may rotate or orient the IR receiver 205 of the device 200 such that it receives location data from IR transmitter 465 but not from IR transmitter 460. In this manner, the device 200 determines that its location is the geographic region associated with IR transmitter 465. Rather than moving the device 200 to different longitudinal or latitudinal coordinates, the user may simply reorient the device 200, thereby changing its location from being in the geographic region associated with IR transmitter 465 to the region associated with IR transmitter 460.

Alternatively or additionally, the median 470 may include an obstacle that prevents a device 200 located on one side of the median 470 from receiving data from the IR transmitter 460, 465 on the other side of the median 470. Thus, the IR signal may be used to determine which side of the median 470 the device is located when GPS would be unable to provide the necessary resolution.

In one embodiment, the device 200 may be preconfigured such that when it determines, using GPS, it is within a certain distance from either Exhibit B or Exhibit C, the device 200 will not use the location data received from the GPS receiver 210 to trigger the application 230. Instead, the device waits until it receives location data via IR receiver 205. The device then uses the location data 225 received from the IR receiver 205 to determine the device's current location. Note that the device 200 may continue to receive and calculate its location based on the GPS signal. Accordingly, once the device 200 determines that its location is outside a predefined distance from Exhibit B or C (or the device 200 no longer receives location data via the IR receiver 205), the device 200 may again use location data 225 based on the GPS signal to determine its location.

In one embodiment, the device 200 may always default to using location data 225 received from an IR transmitter to determine its actual location, even if the device 200 continues to receive reliable location data 225 via the GPS receiver 210. In this manner, the device 200 may not need to be preconfigured to stop using the GPS signal when it is within a predefined distance from Exhibits B and C. Instead, once the device 200 detects an IR signal from either IR transmitter 460 or 465, the device 200 automatically uses these transmitters to determine its location and trigger any applications 230.

In another embodiment, the device 200 may use data that is received in parallel from both the IR receiver 205 and GPS receiver 210. That is, the device 200 may use the GPS signal received via the GPS receiver 210 to determine a location of the device 200. In addition, the device 200 may rely on a supplemental data received via the IR receiver 205 to synchronize content stored in the device 200 to a show in an exhibit. Here, the device 200 may not play the video or text until the location of the devices is within a predefined distance of the exhibit (which is determined using the GPS signal) and the synch signal or other timing data is received via an IR transmitter associated with the exhibit. In a similar example, the device 200 may use the GPS signal to determine location and the IR receiver 205 to determine events that may occur within that geographic location. For example, the GPS receiver 210 may inform the device of its current location at train station while the IR receiver 205 may receive supplemental data that informs the user that a train is about to arrive. In this manner, the GPS and IR signals may be used in combination to improve the user's experience.

Alternatively, the device 200 may transmit, via a wireless communication technique, its current geographic location generated based on the GPS signal to an external computing system. In turn, the computing system may use an IR transmitter network to transmit location specific information (i.e., that a train is about to arrive) to the device 200.

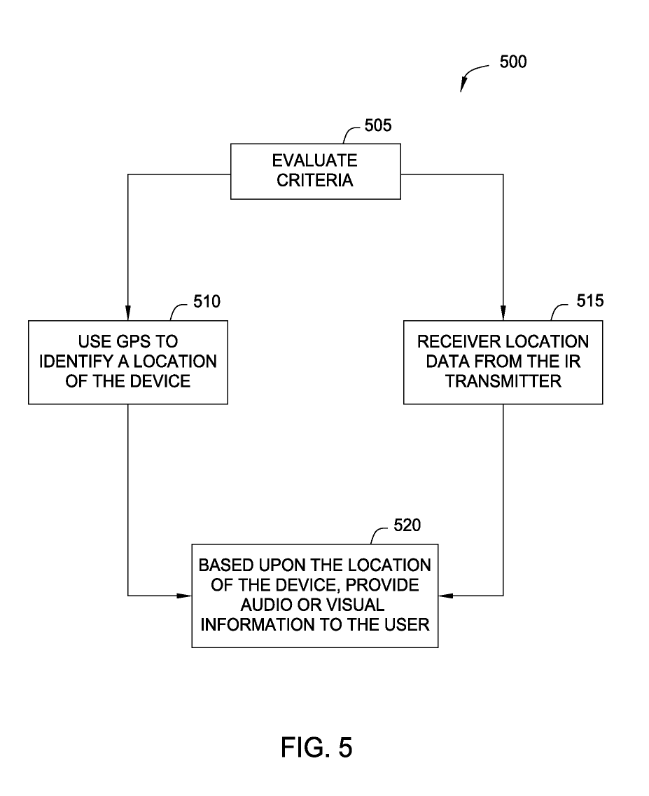

FIG. 5 is a method 500 for determining the location of the device in FIG. 2, according to one embodiment disclosed herein. At step 505, the device 200 evaluates criteria to determine what location data to use. For example, the device 200 may be configured to default to one of an IR signal or a GPS signal regardless if the other signal is currently being received. Further, the criteria may include determining whether the IR signal is lossy (e.g., data packets are corrupted) or that the GPS signal is unreliable (a low signal or signal to noise ratio). Furthermore, the device 200 may ensure it is receiving location data 225 from only one IR transmitter. For example, if the device 200 is within sight of two IR transmitters sending data packets in parallel at a similar wavelength, the packets may interfere with signal reception. Thus, the device 200 may check error correction bits contained in the packets to ensure the packets were received correctly. This validation may ensure that the device 200 is communicating with only one IR transmitter. In this manner, the criteria enable the device 200 to selectively choose which signals to use (or whether to use both signals) to determine a location.

The device 200 may also determine a location of the device using a combination of location data received via the IR and GPS signals. For example, the device 200 may use the geographic location provided by the GPS signal as well as a room location within a building determined by an IR signal to provide the device's location.

Depending on the criteria that is satisfied, at step 510, the device 200 may use a GPS signal to determine its current location. For example, the IR receiver may use less power than the GPS receiver. Accordingly, to save power, the device 200 may default to using IR to determine a current location and only use GPS when an IR signal is unavailable or unreliable (e.g., the IR signal is intermittent). Alternatively, if different criteria is met, at step 515, the device 200 uses the location data 225 from the IR signal to determine a geographic region in which the device 200 is located. As discussed previously, in one embodiment, the device 220 may use a combination of the location data received via both GPS and IR signals to calculate a geographic location. In that example, the criteria may be that the device 200 receives both signal types.

At step 520, the device 200 may use its location to trigger the application 230. This may be performed automatically or after receiving permission from a user of the device. For example, the device 200 may use its display screen 240 to indicate that there is a special video presentation about an exhibit at the current location of the device. If the screen 240 is a touchpad, the user provides an input by interacting with the screen 240 which determines whether the video presentation (i.e., the application 230) is displayed. However, this step may be optional. For example, the device 200 may be a tracking device that is not used to present audio or visual information to a user.

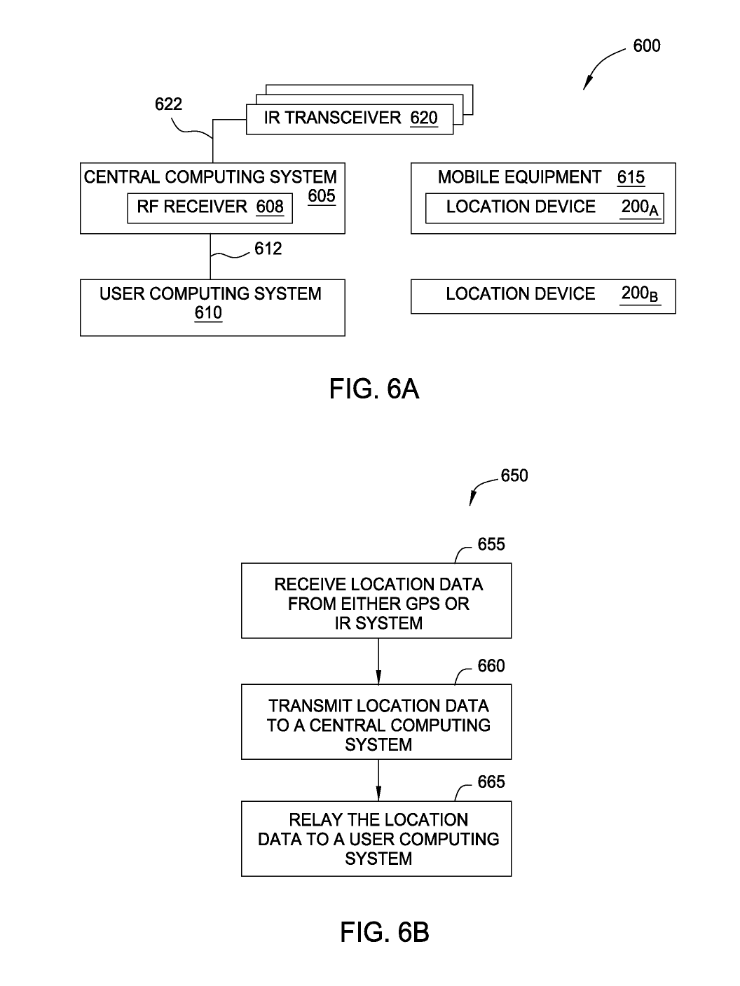

FIGS. 6A-6B illustrate a system and method for transmitting the location of the device in FIG. 2 to a separate computing system, according to embodiments disclosed herein. FIG. 6A illustrates a system 600 with two location devices 200. Location device 200_{A} is located on mobile equipment 615 (or a living creature) which may be any object that can be tracked (e.g., a forklift, an airplane, a cart, etc.). In one embodiment, location device 200_{A} may not have a display screen 240 or other user interactive components which may advantageously reduce the size of the location device 200_{A}. Instead of interacting with a user, the location device 200_{A} may use the transmitter 235 (as shown in FIG. 2) to transmit supplemental data to the central computing system 605.

The central computing system 605 includes a RF receiver 608 for receiving data from an RF transmitter 235 in the location device 200_{A}. That is, the location device 200_{A} may use either GPS or IR transceiver 620 to receive location data from which it determines its current location, but the location device 200_{A} may use a transmitter 235 to transmit supplemental data (e.g., its current location) to the central computing system 605. The transmitter 235 may use any type of wireless communication such as RF, visible light, IR, WiFi, audio, and the like. The central computing system 605 may relay the location of the mobile equipment 615 to a user computing system 610. The communication channel 612 between the central computing system 605 and the user computing system 610 may be a wireless or wired network.

In other embodiments, the transmitted supplemental data may include other information about the device 200 besides its location such as an operational status, environmental condition, and the like. For example, the device 200 may use the transmitter 235 to inform the central computing system 605 that an internal battery is running low on power. This information may aid in preventing the location device 200 from failing. Additionally, the device 200 may transmit an environmental condition such as temperature, humidity, air pressure, and the like based on additional sensors locations on the device 200. For example, the mobile equipment 615 may be sensitive to particular environmental conditions which the central computing system 605 may monitor based on the supplemental data provided by the location device 200_{A}.

The mobile equipment 615 may be a cart that houses certain medical testing equipment. Instead of requiring users of the medical equipment to manually provide the location of the medical equipment, the system 600 may use GPS and IR signals to provide location data 225 to the location device 200_{A}, which, in turn, transmits its current location to the central computing system 605 using the transmitter 235. Whenever a technician attempts to locate the medical equipment using the user computing system 610, the central computing system 605 can transmit the current location of the device 200_{A} to the technician.

In one embodiment, the location devices 200_{A-B} may have transmitters 235 that use IR communication to transmit a current location to the central computing system 605. In this case, the IR transceivers 620 may both transmit location data to the location devices 200_{A-B} and receive a current location from the location devices 200_{A-B}. The IR transceivers 620 relay the current location received from the location devices 200_{A-B} to the central computing system 605. For example, once the mobile equipment 615 moves into the sensor region of one of the IR transceivers 620, the location device 200_{A} may transmit an acknowledgement message to the IR transceiver 620 which informs the central computing system 605 of the mobile equipment's 615 location. However, because IR transmitters require LOS, in situations where there are limited IR transceivers 620, an RF transmitter, rather than an IR transmitter, may be used as the transmitter 235.

In one embodiment, location device 200_{B} may include both a transmitter 235 for transmitting its current location to the central computing system 605 and a display screen 240. For example, the device 200_{B} may be provided to a visitor in an amusement park. The visitor may use the device 200_{B} to interact with exhibits as shown in FIGS. 4A-B. Additionally, the device 200_{B} may continually send location updates to the central computing system 605 using the transmitter 235. The user computing system 610 (e.g., another location device 200) may be given to a friend of the visitor who can monitor the visitor's location within the amusement park via location device 200_{B}. Both the visitor and the friend can find each other within the amusement park using communications provided by the central computing system 605 to the respective devices. In this manner, the device 200_{B} may both receive supplemental data such as synch messages and transmit supplemental data such as the visitor's location.

FIG. 6B illustrates a method 650 of transmitting a current location to a central computing system 605. At step 655, a location device 200 determines its current location using a GPS or IR signal. At step 660, the location device 200 transmits its current location to the central computing system 605. This may be performed by an IR transmitter located on the device 200 that transmits an IR signal to IR transceiver 620. The IR transceiver 620 relays the device's 200 current location to the central computing system 605 using communication channel 622, which may be a wired or wireless network. Alternatively or additionally, the device 200 may use transmitter 235 for transmitting the location data to the RF receiver 608.

In either case, at step 665, the central computing system 605 relays the current location of the device 200 to a user computing system 610. The user computing system 610 may then display the current location of the device 200.

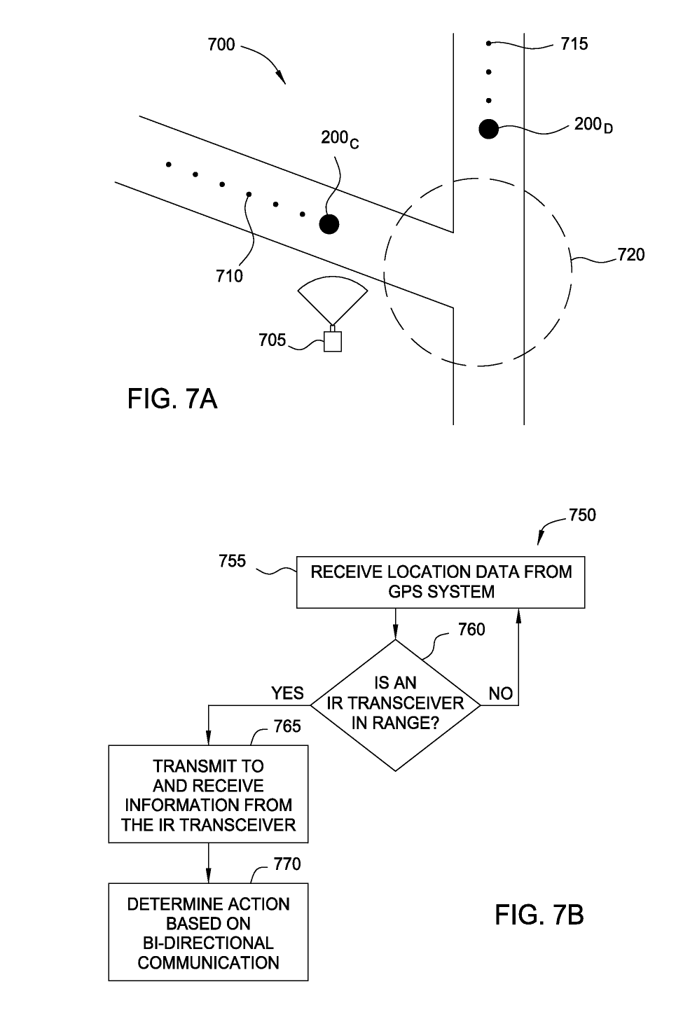

FIGS. 7A-7B illustrate a system and method for bi-directional communication in the system illustrated in FIG. 6A, according to embodiments disclosed herein. FIG. 7A illustrates at system 700 that uses IR and GPS signal in parallel. The system 700 illustrates two location devices 200_{C-D} mounted on mobile equipment whose paths are going to merge at junction 720. For example, location devices 200_{C-D} may be mounted on respective trains. The breadcrumbs 710, 715 illustrate the previous locations of the trains.

Once location device 200_{C} travels into the sensor region of IR transceiver 705, the device 200_{C} may initiate bi-directional communication with the IR transceiver 705 and send a request to the IR transceiver 705 for permission to move into junction 720. The transceiver 705 may be connected to a central computing system that knows the current location of both devices 200_{C-D}. Accordingly, the IR transceiver 705 may relay a message to the location device 200_{C} from the central computing system that instructs the location device 200_{C} to stop the train. For example, the location device 200_{C} may be directly connected to the navigation system of the train and send a message that stops the train.

Once the other location device 200_{D} has safely passed through the junction 720, the IR transceiver 705 may transmit a message to location device 200_{C} that it permits the train to move into the junction 720.

FIG. 7B illustrates a method 750 for bi-directional communication between a location device and an IR transceiver (or other wireless transceiver). At step 755, the location device 200_{C} may receive location data from a GPS signal which it may use to determine its current location. At step 760, the location device 200_{C} may wait until it comes into sight of IR transceiver 705. That is, the location device 200_{C} or IR transceiver 705 may constantly send out discovery messages.

In one embodiment, when the device 200_{C} is not in range of an IR transceiver, it does not perform bi-directional communication. For example, the device 200_{C} may contain an IR transmitter that requires LOS with an external IR transceiver. However, in other wireless communication techniques, such as RF, the transmitter may not need to be in LOS with the device 200_{c}.

Once the location device 200_{C} comes into range of the IR transceiver 705, the device 200_{C} may begin to transmit and receive data from the transceiver 705. As discussed in regards to system 700, the location device 200_{C} may be integrated into a train's navigational system for preventing collisions. However, the method 750 may be used in any embodiment for transmitting information based on the location of the device 200_{c}.

In one embodiment, at step 765, the device 200_{C} may continue to rely on the GPS signal (if available) to determine the device's current location. Thus, even though the location device 200_{C} is within the sensor region of IR transceiver 705, the location device 200_{C} does not receive location data from the IR transceiver 705. Doing so may preserve the limited bandwidth associated with the IR communication method. For example, the IR transceiver 705 may transmit audio to be played on the device 200_{C} that requires most of the bandwidth of the IR communication channel. Thus, while the device is performing bi-directional communication with the IR transceiver 705, it may also receive updated location data from a GPS signal.

At step 770, the location device 200C performs an action based on the data received from the IR transceiver 705. As discussed above, the device 200_{C} may receive a synch message for synchronizing a video or text stored in the device 200_{C} with an animatronic show. Or the device 200_{C} may provide control signals to a vehicle's navigation system to prevent a collision.

### CONCLUSION

A computing device may rely on GPS and IR communication to determine its current location. The limits of GPS may prevent it from reliably providing location data to the computing device in a variety of situations such as in downtown metropolitan areas, geographic regions with thick canopies, in buildings, and the like. As a result, IR may also be used to provide location data to the computing device. For example, an IR transmitter may transmit location data to the computing device which, in turn, uses the location data to identify its current location. In addition, the computing device may receive supplemental data from the second communication technique that, for example, synchronizes the computing device to a real-time event happening at the identified location—e.g., an audio/visual presentation. The device may also transmit supplemental data via the second communication technique. The transmitted supplemental data may be used to, for example, track a location of the device or determine an operational status of the device.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method, comprising:
receiving a plurality of signals at a device configured with a global positional system (GPS) receiver and a wireless signal receiver;
based on the plurality of signals:
identifying a first location of the device using location data received from the GPS receiver,
identifying a second location of the device using location data received from the wireless signal receiver, and
receiving supplemental data associated with a point of interest;
determining an identified location of the device based on at least one of the first and second locations of the device; and
upon determining that the identified location is within a predefined distance from the point of interest, synchronizing, based on the supplemental data, a media output of the device to an ongoing event corresponding to the point of interest.

2. The method of claim 1, wherein the media output of the device synchronized to the ongoing event is at least one of: a video, a textual display, a sound, and an image.

3. The method of claim 1, wherein the wireless signal receiver is configured to receive supplemental data using at least one of a light signal and a radio frequency (RF) signal transmitted from a terrestrial transmitter.

4. The method of claim 1, wherein the ongoing event started before determining that the identified location of the device is within the predefined distance from the point of interest, and wherein the supplemental data is timing information associated with the ongoing event.

5. The method of claim 1, wherein determining the identified location of the device further comprises evaluating criteria to determine whether to use the first location provided by the location data received from the GPS receiver or the second location provided by the location data received from the wireless signal receiver,
wherein the criteria is at least one of: determining the device is within range of a wireless signal transmitter, receiving a data packet containing location data from the wireless signal transmitter, determining that a received GPS signal has a magnitude that exceeds a predefined threshold, determining the GPS signal is unreliable, and determining the GPS signal is not available.

6. The method of claim 1, wherein the second location is based on at least one of: a coordinate location of the wireless signal transmitter and a sensor region of the wireless signal transmitter.

7. The method of claim 1, further comprising:
upon detecting a wireless signal on the wireless signal receiver and while receiving a GPS signal on the GPS receiver, determining the identified location of the device based on the wireless signal and not determining the identified location of the device based on the GPS signal.

8. A device, comprising:
a GPS receiver configured to receive first location data;
a wireless signal receiver configured to receive second location data; and
a processor configured to:
determine a location of the device using one of: the first location data received from the GPS receiver and the second location data received from the wireless signal receiver, and
upon determining that the location of the device is within a predefined distance from a point of interest, synchronizing, based on received supplemental data associated with the point of interest, a media output of the device to an ongoing event corresponding to the point of interest.

9. The device of claim 8, wherein the media output of the device synchronized to the ongoing event is at least one of: a video, a textual display, a sound, and an image.

10. The device of claim 8, wherein the wireless signal receiver is configured to receive supplemental data using at least one of a light signal and a RF signal transmitted from a terrestrial transmitter.

11. The device of claim 8, wherein the ongoing event started before determining that the location of the device is within the predefined distance from the point of interest, and wherein the supplemental data is timing information associated with the ongoing event.

12. The device of claim 11, wherein determining a location of the device further comprises the processor evaluating criteria to determine whether to use the first location data received from the GPS receiver or the second location data received from the wireless signal receiver,
wherein the criteria is at least one of: determining the device is within range of a wireless signal transmitter, receiving a data packet containing location data from the wireless signal transmitter, determining that a received GPS signal has a magnitude that exceeds a predefined threshold, determining the GPS signal is unreliable, and determining the GPS signal is not available.

13. The device of claim 11, wherein determining the location of the device using the second location data received from the wireless signal receiver is based on at least one of: a geographic location of the wireless signal transmitter and a sensor region of the wireless signal transmitter.

14. A device, comprising:
a GPS receiver configured to receive first location data;
an optical data receiver configured to receive second location data;
a processor configured to, upon determining at least one criteria is met, identify a location of the device based on one of the first location data and the second location data; and
a wireless signal transmitter configured to transmit a wireless message containing the identified location of the device.

15. The device of claim 14, wherein the criteria is at least one of: determining the device is within range of an external wireless signal transmitter, receiving a data packet containing location data from the external wireless signal transmitter, determining that a received GPS signal has a magnitude that exceeds a predefined threshold, determining the GPS signal is unreliable, and determining the GPS signal is not available.

16. The device of claim 14, wherein the wireless signal transmitter is configured to transmit the identified location using at least one of an optical data signal and a radio frequency signal.

17. The device of claim 14, wherein the wireless message is received at a central computing system configured to track the geographic location of the device.

18. The device of claim 14, wherein the wireless signal receiver is one of: a visible light optical receiver and IR optical receiver.

19. The device of claim 14, wherein the wireless signal transmitter is a RF transmitter and the wireless signal receiver is a visible light optical receiver.

20. The device of claim 14, wherein the wireless signal transmitter and the wireless signal receiver are portions of an IR optical transceiver.
